(19) United States
(12) Patent Application Publication
(10) Pub. No.: US 2007/0164531 A1
(43) Pub. Date: Jul. 19, 2007

(54) Method and apparatus for rebound control

(76) Inventor: Peter E. Bryant, Las Vegas, NV (US)

Correspondence Address: AARON PASSMAN, 9632 WINDOM POINT AVENUE, LAS VEGAS, NV, 89129, US

(21) Appl. No.: 11/332,083

(22) Filed: Jan. 13, 2006

(51) Int. Cl. B60G 9/00; B60G 21/04

(52) U.S. Cl. 280/124.179; 267/194; 188/313

(57) ABSTRACT

An apparatus and method for rebound control by a rebound coil spring placed within a shock absorber that is aligned along an axis between an axle and a chassis resists motion of the chassis away from the axle. A tube encloses a piston that fits in sliding sealing reciprocal engagement along an axis so controlled fluid flow may pass through passageways damping axial motion of the piston relative to the tube. A lock ring circular group assembly carried upon a shaft and within the tube is spaced apart from the piston and segmented shoes carried on the lock ring circular group assembly, are formed to engage the tube and bear resiliently against the tube in frictional engagement therewith. A rebound coil spring coaxially carried about the shaft and within the tube seats on the segmented shoes and is captured between a shaft bearing and the segmented shoes so for compressively holding the rebound coil spring between and against the segmented shoes during rebound motion and to reciprocate axial with the reciprocating motion of the shaft along the axis. The segmented shoes frictionally engaging the tube during jounce motion to retain the rebound coil spring under compression when the shaft moves the piston away from the lock ring circular group assembly during jounce. The lock ring circular group assembly is positioned axially within the tube in proportion to the amount of jounce sustained during shaft movement for retaining the rebound coil spring against freedom.

### CROSS REFERENCE TO RELATED APPLICATIONS

This application is related to and incorporated by reference:

U.S. Ser. No. 09/803,505 filed on Mar. 9, 2001 entitled Opposing Spring Resilient Tension Suspension System now U.S. Pat. No. 6,761,372.

U.S. Ser. No. 10/033,016 filed on Oct. 26, 2001 entitled Method and Apparatus For Rebound Control now U.S. Pat. No. 6,830,256

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates to and, in particular, to improvements in the methods and apparatus for using a rebound coil spring carried within a shock absorber that is intended to apply the unsprung weight of the axle during rebound to the chassis. More particularly, it is to resist rollover, sway, yaw and other chassis motion using the unsprung weight.

2. Description of Related Art Including Information Disclosed Under 37 CFR 1.97 and 1.98

In recent years the numbers of sport utility vehicles “SUV” and pickup trucks have increased dramatically to the point where those vehicles are more popular than the millions of passenger cars on the road. The SUV and trucks inherently have a higher center of gravity (CG) than normal passenger cars due to the need for higher ground clearance for bad weather travel (snow and ice), off-road use and/or for pickup truck payloads. Vehicles with a higher CG have a greater propensity to sway or even rollover during abrupt lane changes and evasive steering maneuvers than the lower normal passenger cars.

One important arrangement of all these vehicles is the method of suspension used. Except for the use of hydraulic shock absorber damping resistance to rebound, all vehicle chassis and body loads are supported on the vehicle axles with various types of suspensions that have springs that resist primarily load and jounce of each wheel axle. No existing suspensions, except those referenced above, using coil springs, load leaf springs, air springs, torsion bars or rubber blocks suspensions have any other provision for rebound control of the forces due to inertia or gravity type negative suspension loads. Particularly, those rebound forces occurring at the inside wheel during hard cornering or if a wheel drops into a pothole.

Typically, changes in suspension loads while driving straight along a road are caused generally by reactions to bumps, potholes, and roughness encountered by the vehicle wheels during their interaction with the road surface. Thus the suspension springs and associated shock absorbers quell the harshness and movements being transmitted to the chassis.

The sway or side to side rolling motions that vehicles experience due to cornering forces, also cause vehicle springs to be loaded or unloaded, depending upon which way the vehicle is rolling during cornering. Many vehicles have an anti-sway/roll bar installed to help the vehicle body resist the rolling actions. These devices help the vehicle partially resist roll but only as it relates to the body lean, because they are fixed to the sprung mass and are leaning with the body. Thus, they can transfer load from the loaded side and actually reduce the load on the unloaded side of the vehicle. They use the body as a structure to support the torsion bar middle of the anti sway system transferring wheel jounce motion across to the opposite side. The disclosure herein can obviate the need for anti-sway bars, saving the cost of providing and installing them. Shock absorbers only dampen the bouncing movement of the vehicle wheels and suspension caused by the reaction to road surface, cornering and braking. Thus, only the rate of sway may be affected to a minor degree.

In a shock absorber a floating aluminum piston is placed between the fluid moving against the piston within the enclosed end of the shock absorber tube. The floating piston has gas such as nitrogen behind it that is at a preset pressure. This piston does two things, first to pressurize the fluid and damp motion of the vehicle suspension about its preloaded ride height ride height. It is not practical to fill the entire shock body with fluid on both sides of the fluid piston. This ensures that as the fluid moving through passages in the piston moves away from the end of the tube as it would during extension or “rebound” travel, gas pressurization does not permit a vacuum to form behind the fluid piston and sucking against the shock absorber rebound travel. Gas maintains a pressure front against the fluid to ensure that it is induced to pass the fluid through the piston during jounce travel. The fluid piston has passages in it to allow the fluid to pass by it and flexible shims on both sides of the fluid piston are adjusted in strength to set the resistance to flow through the piston during normal movement. Stiffer shims result in higher resistance to the fluid being forced against them.

The use of nitrogen pressure against the piston is typical of existing shock absorber design. The basic tubular shock absorber is well known to skilled artisans, and is a commodity and is disclosed in numerous patents. The typical shock absorber is designed to dampen motion and with coil over springs adjust the ride height and/or spring stiffness.

Paired spring suspensions are connected in series to only support load and jounce with the added spring coupled in line with the main spring for increasing the effective spring constant at the extremes of suspension travel. Those paired springs are in the nature of an overload spring that engages and changes the spring constant at the extremes of wheel travel as such there is no rebound control spring connected to specifically resist rebound forces due to diverging motion of the sprung weight to unsprung weight. The paired springs act in unison to control primarily load and jounce and there is no appreciation of a particular connection to directly apply rebound reaction of unsprung weight to one of the springs. Even with a shock absorber for damping motion and an elastic block to ameliorate the transition between first and second springs for carrying the load there is no structure to apply rebound loads in any paired spring configurations. The prior patents of the same inventor referenced herein and made a part hereof by reference identify the teachings that similarly fail to disclose or teach rebound control of sway or pitch. At best the structures for multiple springs shown in patents have differing spring rates to give an allegedly more comfortable ride but do not specifically disclose rebound control. If the springs are coaxial or in line no disclosure of rebound control of sprung weight is disclosed in prior patents. In particular, no teaching of a rebound spring sufficient to transfer the unsprung weight to the chassis and resist rebound is known. Moreover the working travel of both paired selected to make possible rebound control is unknown.

No existing suspension system suspends the chassis between opposing springs to counter load and jounce and reaction and rebound along different portions of the axle and wheel travel. An opposing spring suspension as disclosed herein can have little effect on the ride stiffness, but stabilizes cornering and evasive maneuvering sway by using the unsprung weight of the axle system thus helping the vehicle to resist roll while maintaining the general ride quality.

Although paired springs are mentioned specifically herein multiple springs stacked, as a unit, abutting each other act only as one continuous variable rate spring.

An influence is delivered on the vehicle center of gravity by opposing spring. The center of gravity of the unsprung mass relative to the center of gravity of the sprung mass is affected during the cornering maneuvers. Without a tension or opposing spring to “tether” the sprung mass to the unsprung mass the unsprung mass does not initially help resist the movement upwards of the sprung mass. This resistance is best appreciated in a vehicle with very heavy unsprung mass relative to a lighter sprung mass during cornering versus a vehicle with light unsprung mass relative to a heavy sprung mass. The former is recognized as undesirable and the latter is greatly preferred and sought after in design of vehicles. Often the physical limits of the vehicle components determine the practical boundaries of the sprung weight to unsprung weight ratio. The disclosure herein has an approach to ameliorate the dynamics of that relationship.

Shock absorbers used in connection with motor vehicle suspension systems absorb unwanted vibrations when movement occurs during various driving conditions. To dampen the unwanted vibrations, shock absorbers are generally connected between the sprung portion (i.e., the vehicle body) and the unsprung portion (i.e., the suspension) of the vehicle and at the onset of motion damping ensues. A piston assembly is located within the working chamber of the shock absorber and is connected to the body of the motor vehicle through a piston rod. Generally, the piston assembly includes a primary valve arranged to limit the flow of damping fluid within the working chamber when the shock absorber is compressed or extended. As such, the shock absorber is able to generate a damping force with motion to smooth or dampen the vibrations transmitted from the suspension to the vehicle body. Typically, these vibrations occur from forces causing movement generally in a vertical direction between the vehicle body and the driving surface.

The greater the degree to which the flow of damping fluid within the working chamber is restricted across the piston assembly, the greater the damping forces that are generated by the shock absorber. It is also possible to implement a primary valve arrangement that produces one magnitude of damping on the compression stroke, and a second magnitude of damping on the rebound stroke but nothing happens until motion begins. These different damping rates are typically constant as varying the sizes of the compression and rebound bypass orifices produce them.

While these shock absorbers produce ride comfort levels ranging from “soft” to “firm,” few, if any, of the known shock absorbers produce varying degrees of damping in a passive manner. Shock absorber systems capable of producing varying degrees of damping force; typically achieve this through the use of control that relies on movement reacting to vertically generated forces resulting upon motion placed on the vehicle suspension.

Every road vehicle manufactured has suspension of one form or another. The suspension is used to isolate the road conditions from the vehicle passengers and ensure a comfortable ride. Typically suspension means that the passenger compartment is mounted on or includes a chassis. Compressed suspension springs are mounted between the chassis and the un-sprung road wheels that are mounted on axles or each wheel is independently sprung under the chassis. When the vehicle is sitting at its typical “curb weight” (Defined by the Society of Automotive Engineers as the normal weight of the finished vehicle plus a driver and full tank of fuel and all necessary fluids) the suspension springs are compressed by the chassis weight to a nominal length and position called “preloaded ride height”. When the vehicle is driven the wheels can move up towards the chassis and this is called “jounce.” When the wheels move away from the chassis as they would if passing over a pot hole or as when the vehicle tips or rolls when experiencing lateral “G” loadings, it is called “Rebound” movement.

Typically the suspension springs absorb the extra loads generated during cornering to some extent. The wheels on the left side or “inside” of the forward/aft center line during a left hand turn experience negative “G” loads due to the weight reaction's through the center of gravity of the chassis body. The chassis rolls and the suspension springs sense that they are being unloaded and try to return to their free length. This is the length that they were at before the weight of the chassis compressed them at preloaded ride height. This means that they actually can increase the amount of body roll during cornering by pushing the chassis up and away from the wheels.

Up until now the only apparatus that has been used to help dampen the suspension travel as it rolls has been the hydraulic shock absorbers installed for this purpose and in some cases anti-roll or sway bars are used to help control the roll. This disclosure applies a rebound spring to oppose the rebound travel of unsprung weight thus reducing vehicle body roll and improving handling. Because the rebound control spring is actuated when the vehicle is at preloaded ride height and works during rebound travel of the unsprung weight, it has little or no influence on jounce movement. FIG. 9 of U.S. Pat. No. 6,761,372, made a part hereof and incorporated herein by reference, of the same inventor as this patent disclosure shows opposing springs on either side of platform in an enclosed cylinder with the lower spring opposing rebound travel or lengthening of the assembly.

### BRIEF SUMMARY OF THE INVENTION

In the disclosed apparatus and method, a rebound coil spring is placed within the shock absorber tube to resist the lengthening of the shock absorber from a position that starts in jounce travel from normal ride height to the full rebound suspension travel position. This rebound coil spring compresses opposing and resisting the forces that are generated when the part of the suspension controlled is unloading as for example during cornering. Namely the forces caused by the vehicle suspension load spring trying to return to its free position and the centrifugal forces naturally resulting during cornering.

Using an additional rebound coil spring mounted within the shock absorber to resist the rebound motion of the sprung weight applied by movement thereof away from the preloaded ride height reduces chassis roll. The shock absorber thus is able to reduce the initiation of rebound travel between the sprung and unsprung weights as the vehicle becomes lighter due to dynamic forces inducing roll or lift of the chassis and vehicle body.

The transitory effects of body roll during cornering flex the load springs on the side of the vehicle following the outside of the turn due to increased transfer weight to that side. Meanwhile the springs on the side of the vehicle, following the inside of the turn, unload extending toward their free position using the axle as a location for inducing lift of the sprung weight on that side resulting in increased body roll. Roll or sway during sudden cornering or evasive maneuvers rotates the vehicle and its center of gravity “CG” around the roll center axis. The roll center axis is a function of the particular vehicle's suspension geometry. Roll or sway is increased if the vehicle center of gravity is raised as in a SUV, four-wheel drive vehicle or truck. A sudden turn opposite the direction of vehicle travel can cause momentum to continue the sway of the vehicle forcing its center of gravity to move laterally past its maximum upright position, and so the vehicle continues on rolling and overturns.

The solution, as disclosed herein, includes an added rebound coil spring mounted coaxial and to compress within the shock absorber tube and about its shaft to act primarily to resist rebound of the suspension from the design ride height position and thereby apply resistive force to the chassis via the shock absorber to reduce lift. Jounce motion presents a problem for the rebound coil spring as it becomes unloaded within the tube and would rattle so a lock ring circular group assembly is added to automatically hold the rebound coil spring slightly compressed even during jounce. The rebound coil spring can more advantageously be added to a strut type suspension for exactly the same purpose. It is an advantage of the present invention that rebound shock absorbers or struts can be easily and inexpensively added as an after market supplement to either the front or rear of an existing vehicle suspension with tubular shock absorbers or struts. It is a further advantage of the present invention that the rebound coil spring has very little influence on ride height or ride stiffness.

The rebound coil spring works from a small amount of jounce travel all the way to full rebound travel of the shock absorber. It works to prevent the onset of roll or pitch from the preloaded ride height, rather than limiting the roll to a certain amount after it has rolled a certain amount. Limiting the roll from the preloaded ride height position serves to reduce the momentum or inertial weight gain that occurs at the initiation of roll and continues after roll has begun. In other words, we seek to eliminate as much roll as possible from the outset. Rebound control preferably overlaps the jounce control; therefore the disclosed system has truly opposed springs, a preferred embodiment.

A rebound coil spring mounted coaxially around the shock absorber piston shaft compresses with rebound travel of the piston inside the shock absorber. That rebound is the reciprocal motion between the piston and an annular cap on the end of the shock absorber fluid chamber. Rebound compresses the rebound coil spring while applying unsprung weight of the wheels, axle, etc. during cornering or braking.

When the shock absorber experiences jounce travel the rebound coil spring is unaffected and would be free to slide down in the shock absorber and even rattle there within if loose. To retain the rebound coil spring in the correct position during jounce movement a unique retaining friction lock ring circular group assembly has been provided. Herein the lower chamber of the cylinder contains hydraulic fluid and piston, spacer and a lock ring circular group assembly keep the rebound coil spring is above the piston and hydraulic fluid for damping. Shock absorber type valves, typically aperture containing washers, called shims, located about the shaft above and below the piston permit hydraulic fluid to travel between chambers in the tube on opposite sides of the piston at restricted rates. The shock absorber with additional rebound coil spring acting in compression for rebound control applies unsprung weight of the axle to the chassis. The effective difference between what the shock absorber does to dampen reciprocation of the cylinder during movement of the piston in the fluid and what the combined shock and rebound coil spring is control sway and pitch under cornering and braking. Shock absorbers only work to dampen travel when the piston is moved; the rebound coil spring stores energy which proportionally transfers unsprung weight to the chassis due to sway or pitch of the chassis during cornering.

FIG. 1 shows a Macpherson strut type shock absorber of the type that could have internal rebound control hidden inside the shock absorber. There is a big improvement in vehicle stability to be gained with rebound control via a rebound coil spring with 150 pound per inch rate in compression installed over the lock ring circular group assembly and applied to the piston. Normally the inside of shock absorber tube would not have sufficient axial space for a rebound coil spring of this capacity and physical size. Strut type shock absorber include large shaft bigger than normally found in regular damping shock absorbers. The diametrically enlarged shaft is a structural member of the strut used for carrying load and turning thus subject to side loads higher than normal shocks endures. This larger rod requires a bigger piston diameter and thus there is room in the strut type shock absorber tube for the addition of the rebound coil spring. Room makes it simple to convert the strut type shock absorber with a rebound coil spring under compression and inside the tube against the lock ring circular group assembly and thus the piston as an integral rebound control. The addition of the rebound control spring also gives the auto manufacturer an extra cost saving because it eliminates the need for anti-sway bars.

### BRIEF DESCRIPTION OF THE DRAWING

FIG. 1 is a view of a strut installed between chassis and axle shown in perspective.

FIG. 2 is a side view in cross section of the strut of FIG. 1 at its preloaded ride height as seen if cut along line 2-2 in FIG. 1.

FIG. 3 is a side view in cross section of the strut of FIG. 1 at a jounce position as seen if cut along line 2-2 in FIG. 1.

FIG. 4 a partial view shown along the axis in enlarged cross section of the way the piston, the shaft, the spacer, the conical washer, the lock ring circular group assembly with segmented shoes, the expansion ring, the rebound coil spring and the tube fit together also in the view is shown junction against the annular cap, the shaft bearing, the shaft, the tube and the cylindrical housing as well as the lock ring-circular group assembly as an enlarged exploded perspective.

FIG. 5 is an enlarged partial view of FIG. 1 of the piston, the tubular spacer, the lock ring circular group assembly and the rebound coil spring there above and at the shaft bushing.

### DETAILED DESCRIPTION OF THE DRAWING

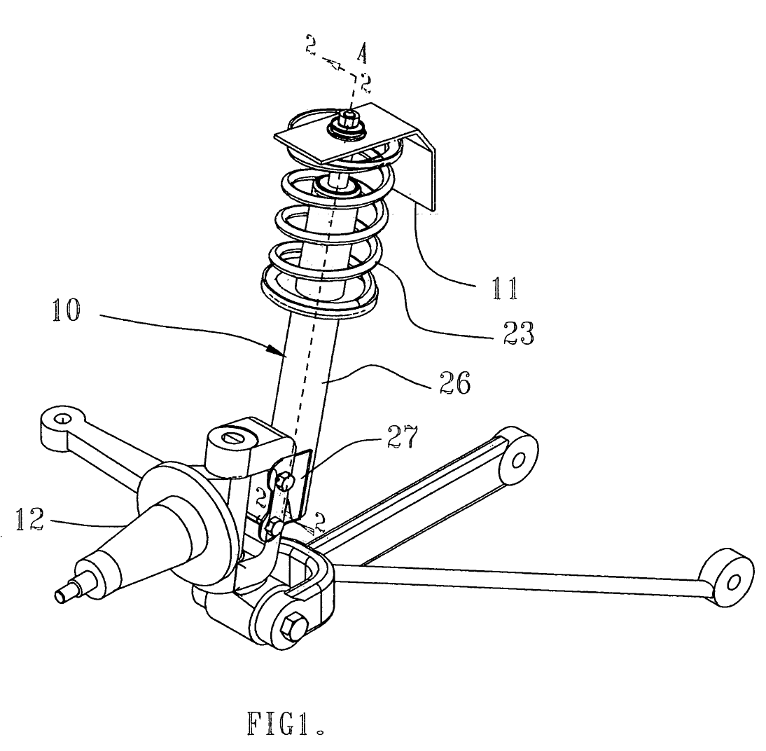

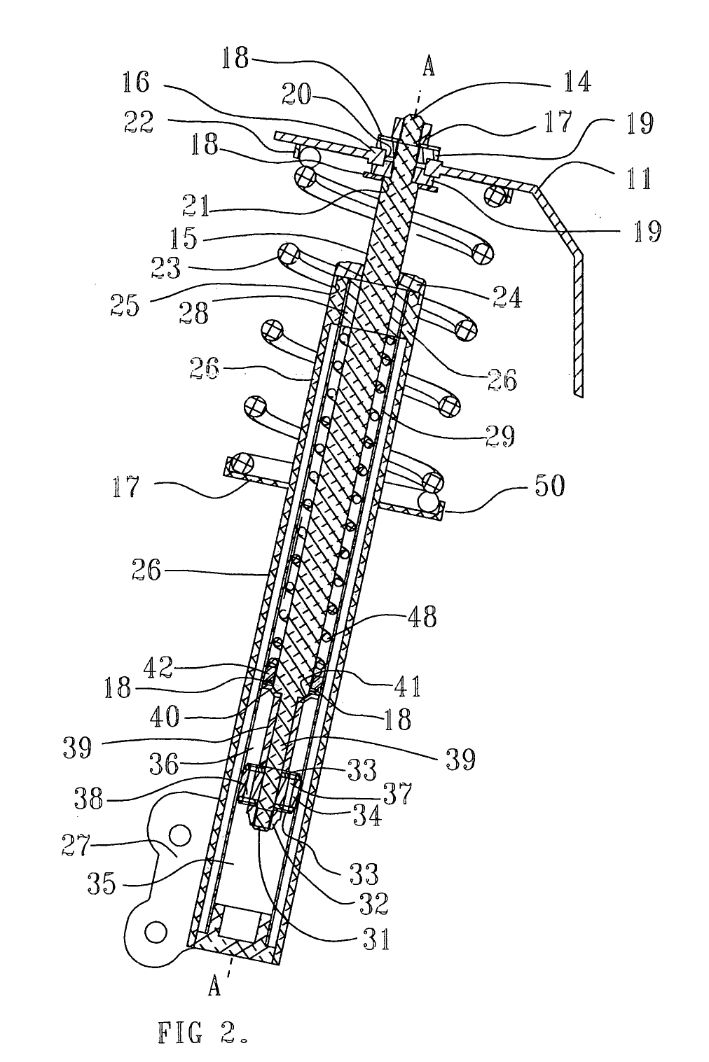

FIG. 1 is a view of a strut or shock absorber assembly 10 installed between chassis 11 and axle 12 shown in perspective. The strut or shock absorber assembly 10 appears normal as the differences disclosed herein are entirely internal and thus not apparent in FIG. 1. That is the strut or shock absorber assembly 10 can be used in place of a standard strut and provide rebound control. FIG. 2 a side view in cross section of the strut of FIG. 1 at its preloaded ride height as seen if cut along line 2-2 illustrates the internal features of the rebound control 13 strut or shock absorber assembly 10 of the present disclosure. Whether called a strut or shock absorber assembly 10, skilled artisans understand that the apparatus or method of rebound operation would be the same. In FIG. 2 there is the chassis attachment threaded mounting stud 14 at the very top of shaft 15 for holding to the chassis suspension mount 16. Specifically a nut 17 threads and engages the chassis attachment threaded mounting stud 14 compressing a metal washer 18 against a resilient bushing 19 against a ringed opening 20 in the chassis 16 and there beneath is another resilient bushing 19 facing as in a mirror image the one disposed above to clamp the ringed opening 20 there between. For that purpose another metal washer 18 rests upon a shoulder 21 of shaft 15 so as the nut 17 is tightened on the chassis attachment threaded mounting stud 14 the bushings 19 are crushed against ringed opening 20 in the chassis suspension mount 16 to retain the strut or shock absorber assembly 10 allowing some relative motion there between. Shaft 15 is in all the figures aligned along axis A-A and while the top and bottom of the strut or shock absorber assembly 10 are always shown the same in all the views skilled artisans can easily understand how the strut or shock absorber assembly 10 could be flipped or used on a rear axle instead of the front as shown in FIG. 1.

About the ringed opening 20 of the chassis suspension mount 16 is a seat 22 so that a load spring 23 in the form of a coil that can set there against and be held thereby in depending coaxial alignment with axis A-A in parallel spaced relation to shaft 15. Along shaft 15 first rests in sliding sealing engagement an annular cap 24 with a centered opening to circumscribe the shaft 15. On shaft 15 there is a downwardly disposed rim to fit a necked in end 25 of a cylindrical housing 26 that is elongate and had at its opposite lower end an axle mount 27. Just inside the cylindrical housing 26 is a shaft bearing 28 sized to engage a tube 29 depending down from the annular cap 24 and hold same against the inside of the cylindrical housing 26.

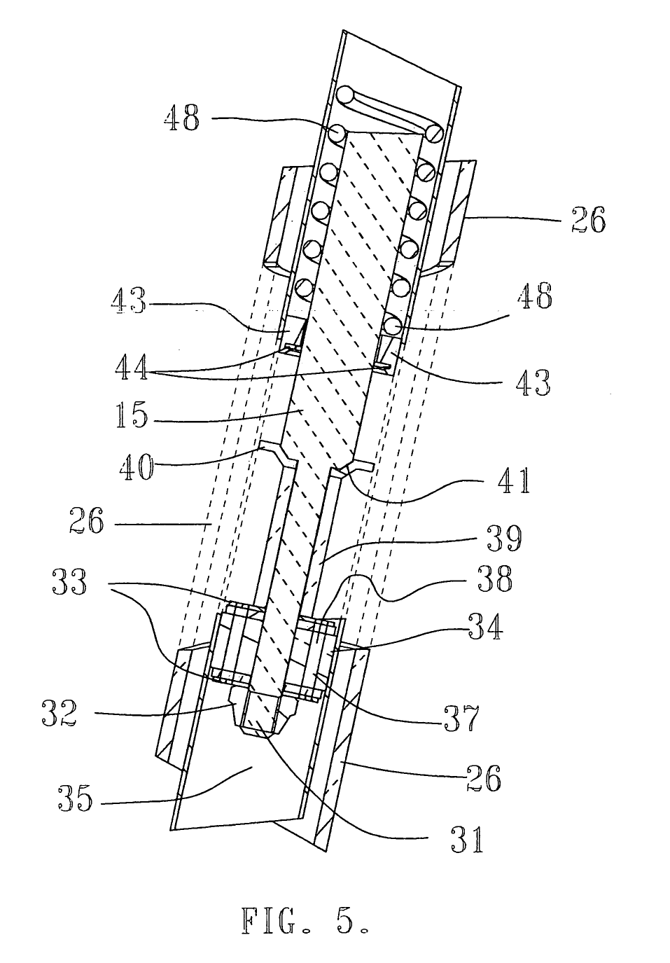

Shaft 15 has an increased diameter from its shoulder 21 to a reduced lower shank 30 that terminates in a bottom threaded stud 31, see FIGS. 2, 3, 4, or 5 for detail. Piston retaining nut 32 holds shims 33 sandwiching piston 34 there amidst to move through lower damping chamber 35 and upper damping chamber 36 in a manner used in most tubular strut or shock absorber assemblies 10. In particular, the fluid is restrained from passing from lower chamber 35 to upper chamber 36 by passageways 37 in the shims 33 and piston which present a circuitous path 38 to the fluid flow. As the piston 34 reciprocates up and down inside tube 29 it is sealed there against to only allow fluid to pass through passageways 37 in the shims 33 and piston 34. A tubular spacer 39 surrounds reduced lower shank 30 in upper chamber 35 to hold the piston 34 against the piston retaining nut 32. A conical washer 40 rests a top tubular spacer 39 and against a beveled transition 41 between the shaft 15 and the reduced lower shank 30 so the tubular spacer 39 is retained unable to move on the reduced lower shank 30. FIG. 5 is an enlarged partial view of FIG. 1 of the piston, the tubular spacer 39, the lock ring assembly circular group 42 and the rebound coil spring 48 there above and at the shaft bearing 28. The operation and parts associated with the lock ring assembly circular group 42 should be apparent in FIG. 5.

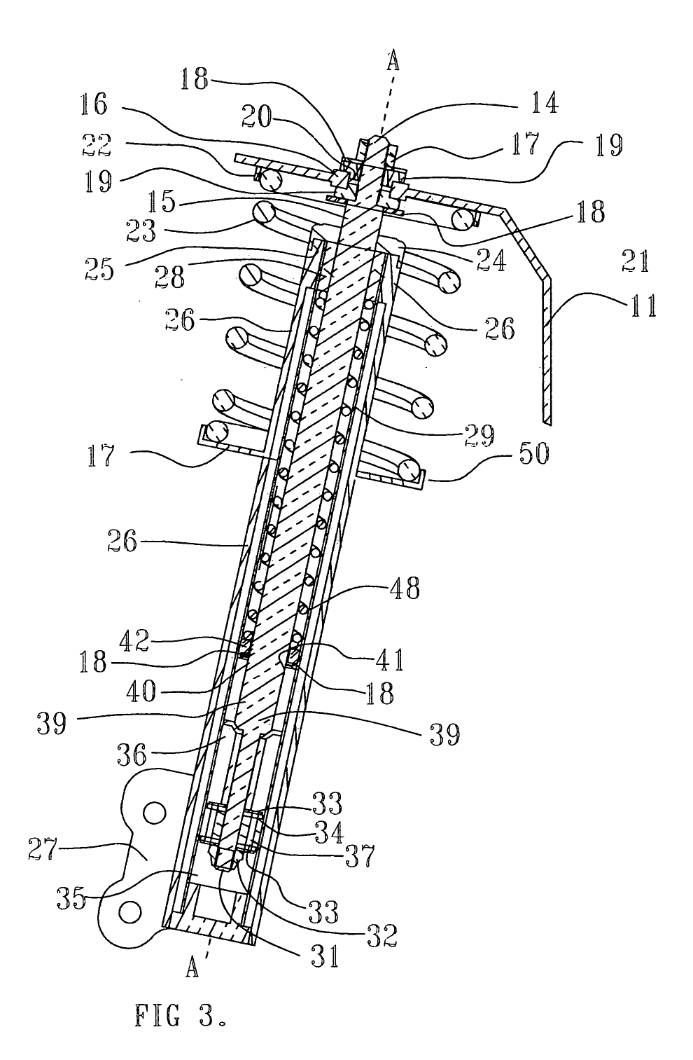

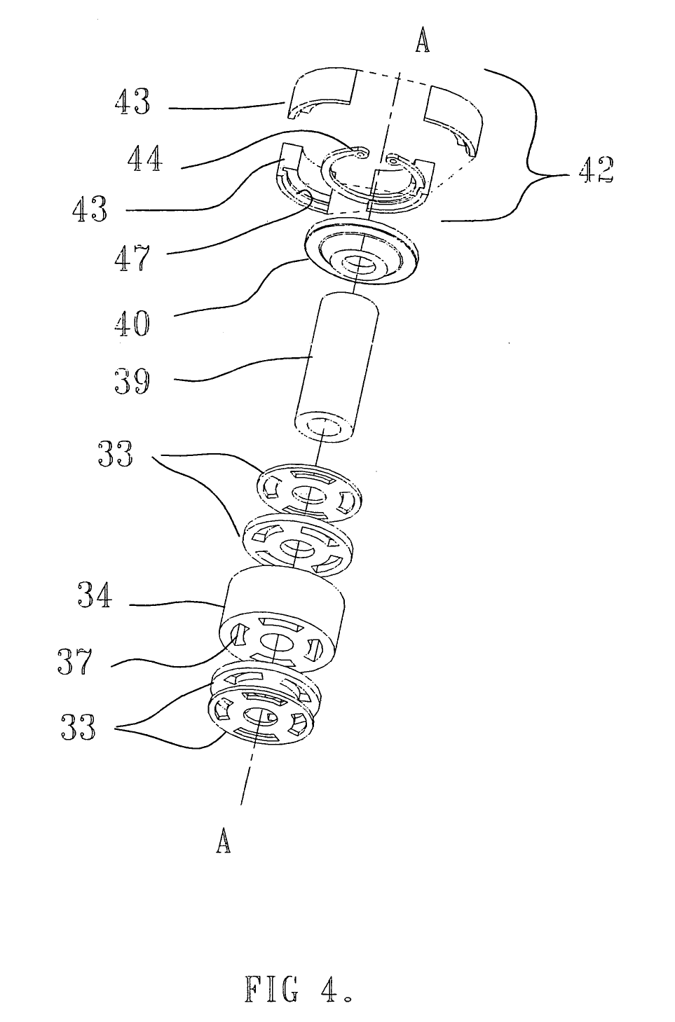

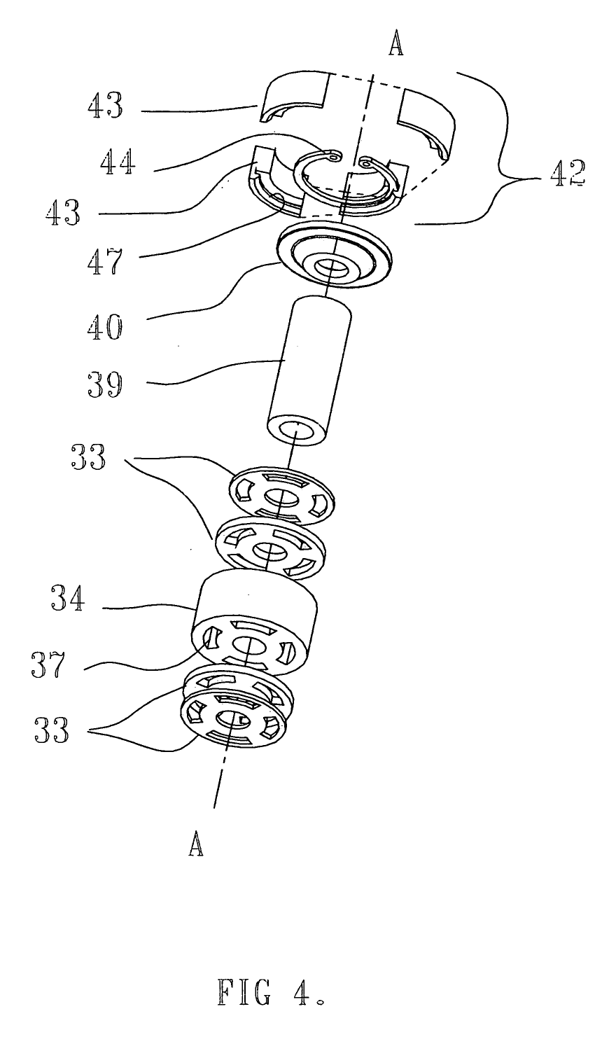

Above conical washer 40 rides lock ring assembly circular group 42 best shown in FIGS. 4 and 5. Lock ring assembly circular group 42 includes segmented shoes 43 circumscribing an internal expansion ring 44 made of spring steel and fit with opposed apertures 45 separated by split ends 46. This common piece of industrial hardware is typically drawn together via the opposed apertures 45, using split ring pliers (not shown) having pins that engage with the opposed apertures 45. Under the control of the pliers the ring is placed into an internal groove 47 in the segmented shoes 43 and then released. The internal groove 47 shown in FIGS. 4 and 5 is sized for receiving internal expansion ring 44 when the segmented shoes 43 are fit within the tube 29, see FIG. 5. In the FIG. 4 a partial view shown along axis A-A in enlarged cross section of the way piston 34, shaft 15, tubular spacer 29 the conical washer 40, lock ring assembly circular group 42 with segmented shoes 43, expansion ring 44 cooperate within tube 29 inside cylindrical housing 26. FIG. 5 is a partial cross section cut away for purposes of clarity. More specifically the exploded view shows four segmented shoes 43 formed of sections of a circle. Those are made of friction material which engages the inside of tube 29 and resists sliding. Materials such as polymers, brake or clutch compositions are possibilities depending on the particular application but the preferred material is Delrin polymer by DuPont. Above the lock ring assembly circular group 42 rides a rebound coil spring 48 which coaxially surrounds shaft 15 located within tube 29 sitting between lock ring assembly circular group 42 beneath it and the shaft bearing 28 above it. The rebound coil spring 48 is never free to rattle or bounce within strut or shock absorber assembly 10. Rebound motion compresses rebound coil spring 48 as shown in FIG. 2 where the load spring 23 is shown relaxed while rebound coil spring 48 is compressed thus applying the unsprung weight on axle mount 27 to the chassis 11. Cylindrical housing 26 is located coaxial about tube 29 against annular cap 24 at one end and axle mount 27 at the other end so compressing load spring 23 is positioned coaxial to tube 29 and about cylindrical housing 26 between axle mount 27 and chassis suspension mount 16 of the vehicle for supporting chassis 11 relative to axle mount 27 at a preloaded vehicle ride height position for resisting jounce motion along axis A-A. FIG. 3 is a side view in cross section of the strut of FIG. 1 at a jounce position as seen if cut along line 3-3 in FIG. 1. More importantly, the jounce position of the lock ring 40 is shown with the segmented shoes 43 against the tube 29 to hold the rebound coil spring thus restricting its freedom to rattle within the tube 29.

For support of the load spring 23 a flange 50 extends radially outwardly from the cylindrical housing 26 and is axially located amid the ends of cylindrical housing 26. Flange 50 is positioned for supporting thereupon load spring 23 with necked in end 25 of shaft 15 projecting through annular cap 24 for mounting to chassis suspension mount 16 while load spring 23 bears against chassis 11. In FIG. 3 a side view in cross section of the strut of FIG. 1 at a jounce position as seen if cut along line 3-3 load spring is shown compressed while rebound coil spring 48 is relaxed but not free to move about or rattle. Consequently FIGS. 2 and 3 show the travel of strut or shock absorber assembly 10 and how lock ring assembly circular group 42 maintains rebound coil spring when jounce occurs. A method of rebound control with rebound coil spring 48 placed within strut or shock absorber 10 that is aligned along axis A-A between axle mount 27 and a chassis 11 resists motion of chassis 11 away from axle mount 27 has steps. Aligning shaft 15 threaded at opposite ends with axis A-A when inside strut or shock absorber assembly 10 is a step. Retaining piston 34 with a central hole 49 near bottom threaded stud 31 of shaft 15 and piston permitting passage of controlled fluid flow through passageways 37 is a step. Enclosing within tube 29 piston 34 that fits therein in sliding sealing reciprocal engagement along axis A-A so controlled fluid flow may pass there through damping axial motion of piston relative to tube 29 is a step. Surrounding coaxially part of shaft 15 with tube 29 at shaft bearing 28 opposite piston 34 is a step. Closing tube 29 with annular cap 24 affixed above shaft bearing 28 about shaft 15 and sealing tube 29 to shaft 15 but permitting sliding rotating engagement between shaft 15 and annular cap 24 is a step. Locating shaft bearing 28 within tube 29 adjacent annular cap 24 and between tube 29 and shaft 15 for supporting shaft 15 passing there through for sliding rotating engagement of shaft 15 relative to tube 29 is a step. Carrying lock ring assembly circular group 42 upon shaft 15 and within tube 29 and spaced apart from piston 34 is a step. Carrying segmented shoes 43 on lock ring assembly circular group 42, segmented shoes 43 formed to engage tube 29 and bear resiliently against tube 29 in frictional engagement therewith is a step. Locating rebound coil spring 48 coaxially about shaft 15 and within tube 29 so rebound coil spring 48 sitting on segmented shoes 43 of lock ring assembly circular group 42 is a step. Capturing rebound coil spring 48 between shaft 15 bearing and segmented shoes 43 so tube 29, shaft 15 and shaft bearing 28 work together for compressively holding rebound coil spring 48 between and against segmented shoes 43 during rebound motion and to reciprocate axial with the reciprocating motion of shaft 15 along axis A-A is a step. Engaging frictionally segmented shoes 43 with tube 29 during jounce motion to retain rebound coil spring 48 under compression when shaft 15 moves piston 34 away from lock ring assembly circular group 42 during jounce so segmented shoes 43 automatically position lock ring assembly circular group 42 along axis A-A for maintaining rebound coil spring 48 compressed between lock ring assembly 42 and shaft bearing 28 under and through jounce motion of strut or shock absorber assembly 10 is a step.

The method includes the steps of carrying cylindrical housing 26 located coaxial about tube 29 against annular cap 24 at one end and mounting axle mount 27 at the other end; compressing load spring 23 positioned coaxial to tube 29 and about cylindrical housing 26 between axle mount 27 and chassis suspension mount 16 of the vehicle for supporting chassis 11 relative to axle mount 27 at a preloaded vehicle ride height position for resisting jounce motion along axis A-A, and extending flange 50 radially outwardly from the cylindrical housing and axially located amid the ends of cylindrical housing 26, flange 50 for supporting thereupon load spring 23 with necked in end 25 of shaft 15 projecting through annular cap 24 for mounting to chassis suspension mount 16 while load spring 23 bears against chassis 11.

The method includes the step of having in segmented shoes 43 internal groove 47 and internal expansion ring 44 seated there within for engaging and biasing segmented shoes 43 so internal expansion ring 43 forces segmented shoes 43 against tube 29 so they drag with frictional engagement due to the radial force applied by internal expansion ring 44 to internal groove 47 of segmented shoes 43. The method includes the steps of positioning lock ring assembly circular group 42 axially within tube 29 in proportion to the amount of jounce sustained during shaft 15 movements for retaining rebound coil spring 48 against freedom. While apparatus and method are shown and described the claims that follow seek to cover variations in structure, materials and steps of operation within the abilities of ordinary artisans.

1. An apparatus for rebound control by a rebound coil spring placed within a shock absorber that is aligned along an axis between an axle and a chassis, the rebound control apparatus to resist motion of the chassis away from the axle comprising:
a shaft threaded at opposite ends for alignment with the axis when in the shock absorber;
a piston with a central hole retained near one threaded end of the shaft, the piston having passages to permit controlled fluid flow there through;
a tube having opposite ends, the tube enclosing there within the piston on the shaft that fits in the tube for sliding sealing reciprocal engagement along the axis so controlled fluid flow may pass through the passages damping axial motion of the piston relative to the tube, the tube coaxially surrounding part of the shaft at the end opposite the piston;
an annular cap on the tube to close it about the shaft, the annular cap sealing the tube to the shaft but permitting sliding rotary engagement between the shaft and the annular cap;
a shaft bearing within the tube adjacent the annular cap, the shaft bearing located between the tube and the shaft for supporting the shaft passing there through for sliding rotary engagement of the shaft relative to the tube;
a lock ring circular group assembly carried upon the shaft and within the tube, the lock ring circular group assembly spaced apart from the piston;
segmented shoes carried on the lock ring circular group assembly, the segmented shoes formed to engage the tube and bear resiliently against the tube in frictional engagement therewith, and
a rebound coil spring coaxially carried about the shaft and within the tube, the rebound coil spring seated on the segmented shoes of the lock ring circular group assembly, the rebound coil spring captured between the shaft bearing and the segmented shoes so the tube, the shaft and the shaft bearing work together for compressively holding the rebound coil spring between and against the segmented shoes during rebound motion and to reciprocate axial along the axis with the reciprocating motion of the shaft, the segmented shoes frictionally engaging the tube during jounce motion to retain the rebound coil spring under compression when the shaft moves the piston away from the lock ring circular group assembly during jounce so the segmented shoes automatically position the lock ring circular group assembly along the axis and maintain the rebound coil spring compressed between the lock ring circular group assembly and the shaft bearing under and through jounce motion of the shock absorber.

2. The apparatus of claim 1 with a cylindrical housing located coaxial about the tube against the annular cap at one end carrying an axle mount for the axle at the other end;
a load spring positioned coaxial to the tube and about the cylindrical housing, the load spring compressed between the axle and the chassis of the vehicle for supporting the chassis relative to the axle at a preloaded vehicle ride height position to resist jounce motion along the axis, and
a flange extending radially outwardly from the cylindrical housing and axially located amid the ends of the cylindrical housing, the flange for supporting thereupon the load spring so the shaft projects through the annular cap for mounting to the chassis when the load spring bears against the chassis.

3. The apparatus of claim 1 wherein the segmented shoes have a internal groove and an expansion ring seats with in the internal groove for engaging and biasing the segmented shoes, the expansion ring forcing the segmented shoes against the tube so that the segmented shoes drag with frictional engagement due to the radial force applied by the expansion ring to the internal groove of the segmented shoes.

4. The apparatus of claim 3 wherein the segmented shoes are cut into sections forming a complete lock ring circular group assembly circular group.

5. The apparatus of claim 4 wherein the segmented shoes are cut into four sections forming a complete lock ring circular group assembly circular group.

6. The apparatus of claim 1 wherein the segmented shoes are made of a firm polymeric material.

7. The apparatus of claim 6 wherein the segmented shoes are molded of nylon.

8. A method of rebound control with a rebound coil spring placed within a shock absorber that is aligned along an axis between an axle and a chassis, the method of rebound control for resisting motion of the chassis away from the axle having steps of:
aligning a shaft threaded at opposite ends inside the shock absorber with the axis;
retaining a piston with a central hole near one threaded end of the shaft and the piston permitting passage of controlled fluid flow through passageways there through;
enclosing within a tube having opposite ends the piston that fits therein in sliding sealing reciprocal engagement along the axis so controlled fluid flow may pass there through damping axial motion of the piston relative to the tube;
surrounding coaxially part of the shaft at the end opposite the piston with the tube;
closing the tube with an annular cap affixed on the end about the shaft and sealing the tube to the shaft but permitting sliding rotating engagement between the shaft and the annular cap;
locating a shaft bearing within the tube adjacent the annular cap and between the tube and the shaft for supporting the shaft passing there through for sliding rotating engagement of the shaft relative to the tube;
carrying a lock ring circular group assembly upon the shaft and within the tube and spaced apart from the piston;
carrying segmented shoes on the lock ring circular group assembly, the segmented shoes formed to engage the tube and bear resiliently against the tube in frictional engagement therewith;
locating a rebound coil spring coaxially about the shaft and within the tube, the rebound coil spring sitting on the segmented shoes of the lock ring circular group assembly;
capturing the rebound coil spring between the shaft bearing and the segmented shoes so the tube, the shaft and the shaft bearing work together for compressively holding the rebound coil spring between and against the segmented shoes during rebound motion and to reciprocate axial with the reciprocating motion of the shaft along the axis, and
engaging frictionally the segmented shoes with the tube during jounce motion to retain the rebound coil spring under compression when the shaft moves the piston away from the lock ring circular group assembly during jounce so the segmented shoes automatically position the lock ring circular group assembly along the axis for maintaining the rebound coil spring compressed between the lock ring circular group assembly and the shaft bearing under and through jounce motion of the shock absorber.

9. The method of claim 8 with the steps of carrying a cylindrical housing located coaxial about the tube against the annular cap at one end and mounting the axle at the other end;
compressing a load spring positioned coaxial to the tube and about the cylindrical housing between the axle and the chassis of the vehicle for supporting the chassis relative to the axle at a preloaded vehicle ride height position for resisting jounce motion along the axis, and
extending a flange radially outwardly from the cylindrical housing and axially located amid the ends of the cylindrical housing, the flange for supporting thereupon the load spring with the shaft projecting through the annular cap for mounting to the chassis while the load spring bears against the chassis.

10. The method of claim 8 with the step of having in the segmented shoes an internal groove and an expansion ring seated there within for engaging and biasing the segmented shoes, the expansion ring forcing the segmented shoes against the tube so that the segmented shoes drag with frictional engagement due to the radial force applied by the expansion ring to the internal groove of the segmented shoes.

11. The method of claim 8 with the step of positioning the lock ring circular group assembly axially within the tube in proportion to the amount of jounce sustained during shaft movements for retaining the rebound coil spring against freedom.
